(19) United States
(12) Patent Application Publication
(10) Pub. No.: US 2003/0161266 A1
(43) Pub. Date: Aug. 28, 2003

(54) Monitoring and stimulating of complex systems, in particular of flow and congestion mechanisms and control in communication networks

(76) Inventors: Francois Baccelli, Meudon (FR); Dohy Hong, Fontenay Sous-Bois (FR)

Correspondence Address: FOLEY AND LARDNER, SUITE 500, 3000 K STREET NW, WASHINGTON, DC, 20007, US

(21) Appl. No.: 10/220,014

(22) PCT Filed: Feb. 28, 2001
(86) PCT No.: PCT/FR01/00579

(30) Foreign Application Priority Data
Mar. 1, 2000 (FR) 00/02656

(51) Int. Cl. H04L 1/00

(52) U.S. Cl. 370/229; 370/235

(57) ABSTRACT

The invention concerns a device and a method assisting in monitoring and/or simulating a complex system, in particular a telecommunication network. It consists in storing data in matrix form, of dynamically variable structure, with iterative multiplication in max-plus algebra of a current matrix of network data and an instantaneous matrix of the network parameters.

The invention relates to the monitoring and simulation of complex systems.

In the field of flux and congestion control in communication networks, in particular of the internet type, detailed analysis of the output offered is desired in order to estimate the respective effects of network parameters.

With the development of on-line communication techniques and the problems encountered, particularly congestion, various protocols for flux and congestion control have been published, in particular TCP (transmission control protocol) control.

The analysis methods of these protocols are known. Among these known methods, one based on an adapted mathematical expression of output in a TCP-type protocol has given rise to an analytical approach for control. The principle on which this method is based is described in particular in:

M Mathis, J Semske, J Mahdavi and T Ott, “The Macroscopic Behaviour of the TCP Congestion Avoidance Algorithm”, Computer Communication Review, 27(3), July (1997).

This method, although promising, showed its limitations in practical applications, in particular the fact that the random nature of the traffic is only partially taken into account, or that it needs an approximation of all the nodes of the network to a single equivalent, virtual node.

Another known method, which takes more account of the stochastic approach, has made it possible to apprehend the random nature of the traffic. This method, which is more recent, derives from the principle described in the following works:

Padhye, J, Firiou, V. Towsley, D, and Kurose, J “Modeling TCP throughput: a simple model and its empirical validation”, Proc. of ACM SIGCOMM (1998)

Padhye. J, Firiou, V, Towsley, D, “A Stochastic Model of TCP Reno Congestion Avoidance and Control”, Technical Report, 99-02, CMPSCI, Univ. of Massachusetts, Amherst (1999).

However, this method has also shown limitations, in particular the fact that it still requires approximation of all the nodes of the network to an equivalent node.

The present invention has just improved the situation.

According to a different approach, the invention proposes to use a representation in algebra known as the “max-plus” of complex systems, such as communication networks and in particular of flux and congestion control.

In order to obtain the detail of mathematical principles on which such a representation is based, one can refer to the following work:

F Baccelli, G Cohen, G J Olsder, and J P Quadrat, Synchronization and Linearity, Wiley (1992).

Globally, scalar max-plus algebra is a semi-ring on the real straight line, where addition becomes the “max” function (greatest value from a set of values) and multiplication, the “plus” (total). The use of max-plus algebra makes it possible to return the calculations of a complex system to a simple matrix representation.

The Applicants have shown and verified in practice that the use of max-plus algebra adapts very satisfactorily to the monitoring and simulation of systems such as a communications network, which may be controlled or otherwise. It makes is possible to overcome the random nature of the network parameters whilst considering a plurality of nodes. Moreover, the Applicants have shown that the representation of a network using a TCP protocol was linear in the max-plus algebra, which makes it possible in practice to apply simple data processing.

The present invention therefore relates to a device for aiding monitoring and/or simulation of a complex system, in particular of a communications network.

According to a first important feature of the invention, the device comprises

a memory for storing a first set of data representing parameters of the network as well as for receiving at least a second set of data representing events in the network, a portion of the memory being reserved for storing data in matrix form,

a computing unit capable of effecting on at least two matrices of dynamically variable structure an operation forming a product according to the algebra known as MAX-PLUS,

a modelling unit for constructing at least a first matrix and a current matrix respectively according to the first set of data and second set of data according to a selected model, and

a pilot unit for applying iteratively the first matrix and the current matrix to the computing unit, the product matrix obtained becoming a new first matrix.

Preferably, the first data comprising information about the topology of the network, such as the number of routers crossed by the connection to be monitored or simulated, the properties of these routers (memory sizes known as “buffers” or the like), the statistical properties of the traffic available on the network, etc.

According to another advantageous feature of the invention the modelling unit comprises:

a static modelling sub-unit for constructing the first matrix according to the first set of data, and

a dynamic modelling sub-unit for constructing at least one current matrix according to the second set of data.

Advantageously, the device according to the invention is capable of processing matrices comprising dynamically variable coefficients, of which at least the aforesaid current matrix is one. In the processing carried out by the device according to the invention, the matrices constructed are advantageously of the same size.

These second data preferably comprise information relating to losses in the network, transverse fluxes in the network, relative to a controlled connection to be monitored or simulated, to congestion in the network, or even to the overtaking of delays in the network known as ‘time out’.

According to another advantageous preferred feature, the product matrix obtained is a vector represented by a single-column matrix, which makes it possible to limit the processing and its duration. The first matrix, representing the network parameters, is advantageously structured from the start as a vector.

According to a second important feature of the invention, the product matrix obtained represents an output in the network associated with the connection to be monitored or simulated, an average output in the network, or fluctuations of an instantaneous output in the network.

According to a third important feature of the invention, the modelling unit is contrived to construct a plurality of matrices successively, in a number corresponding substantially to the number of packages in the network.

The selected model preferably comprises the consideration of the variable size of a window used for controlling the number of packages in the network.

This may be a network controlled by a TCP-type protocol, comprising typically routers with a ‘first-come, first-served’-type discipline, or again routers with a WFQ(weighted fair queuing)-type discipline. The TCP protocol controlling the network may also be based on a Reno or Tahoe model, as will be seen below.

The service of the network may be determinist, or random, as will be seen more fully below.

The present invention also aims at a method to aid the monitoring of a complex system, in particular a communications network. Such a method comprises globally the following stages:

a) obtain first data representing network parameters,

b) construct a first matrix according to a selected model according to the first data,

c) receive at a selected instant at least a second set of data representing events in the network,

d) construct at least one second matrix of variable dynamic structure according to a selected model according to the second set of data, and

e) carry out on the matrices an operation forming a product according to the algebra known as MAX-PLUS, the product matrix obtained representing the state of the network at the aforesaid selected instant.

If it is desired to follow a temporal evolution of the state of the network at selected instants, the method advantageously comprises the following supplementary stage:

f) repeat at selected instants the stages c), d) and e), whereas the product matrix obtained becomes the first matrix after stage e).

A further object of the present invention is a method of simulating a complex system, in particular flux and congestion mechanisms and controls in a communication network. This method comprises globally the following stages:

a) obtain first data representing parameters belonging to the network,

b) construct a first matrix according to a selected model according to the first data,

c) simulate events on the network and provide at least a second set of data representing these events,

d) construct at least one second matrix according to the selected model, according to the second set of data, and

e) carry out on the matrices an operation forming a product according to the algebra known as MAX-PLUS, the product matrix obtained representing the state of the network being subjected to these events.

In order to foresee an evolution of the state of the network according to the events to which it is subjected, this method advantageously comprises the following supplementary stage:

f) repeat for successive events stages c), d) and e), whereas the product matrix obtained becomes the first matrix after stage e).

Further features and advantages of the invention will appear from the detailed description below and the attached drawings, which show:

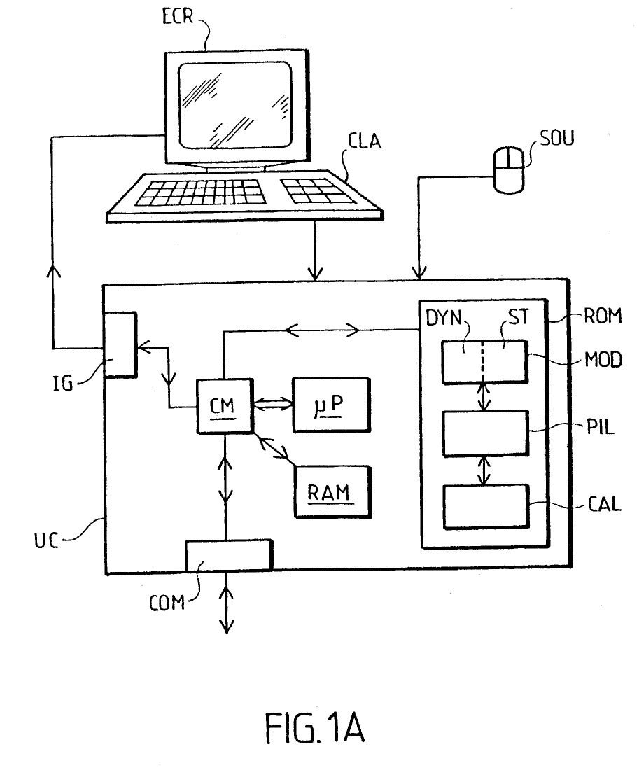

FIG. 1A, diagrammatically a device according to the present invention,

FIG. 1, diagrammatically a number K of queues in tandem on a network with flux control,

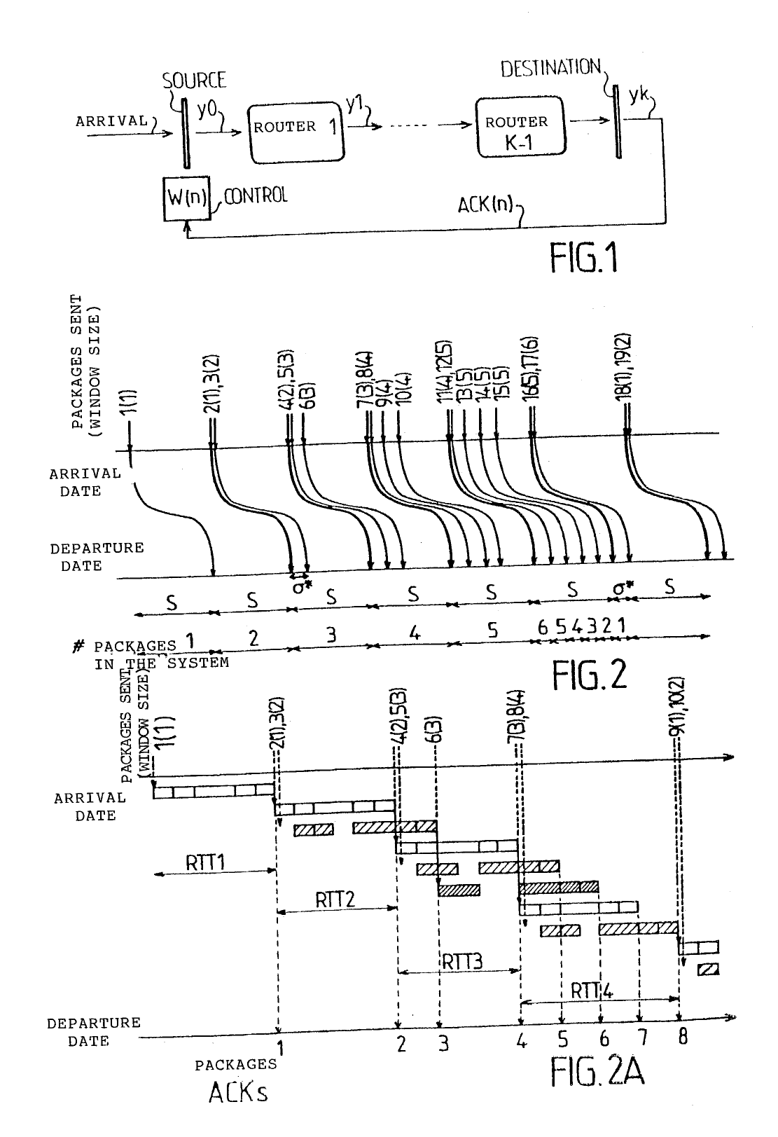

FIG. 2A, a step-by-step evolution of daters and of the size of a window used to control the number of packages in the network,

FIG. 2, interactions between a plurality of packages in the network,

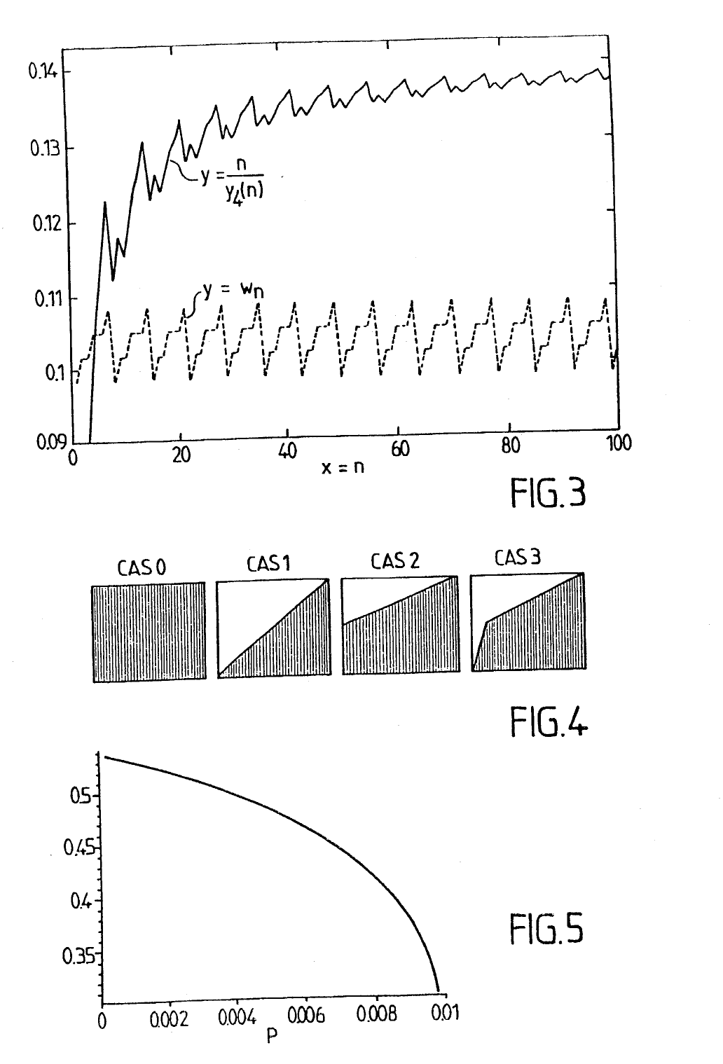

FIG. 3, a variation in output (curve in solid lines), obtained by simulation, in a TCP protocol network based on the Tahoe model without the exponential phase,

FIG. 4, a graphic interpretation of the asymptotic outputs in a TCP-protocol network based on the Reno model with deterministic delays,

FIG. 5, a variation in output, obtained by simulation and showing a reduction in output in the case of random losses in the network,

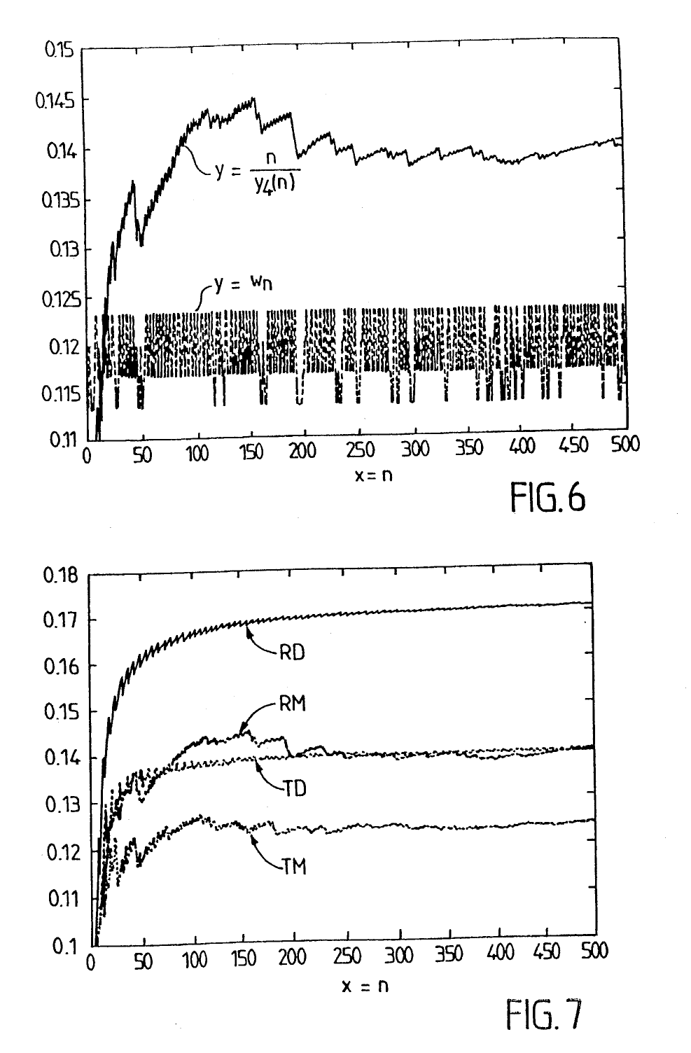

FIG. 6, a variation in output (curve in solid lines), obtained by simulation, in a TCP-protocol network based on a markovian Reno model,

FIG. 7, compared output variations, obtained by simulation, in TCP-protocol networks, based respectively on a determinist Reno model RD (solid lines), a markovian Reno model RM (long dotted lines), a determinist Tahoe model TD (medium dotted lines), and a markovian Tahoe model TM (short dotted lines).

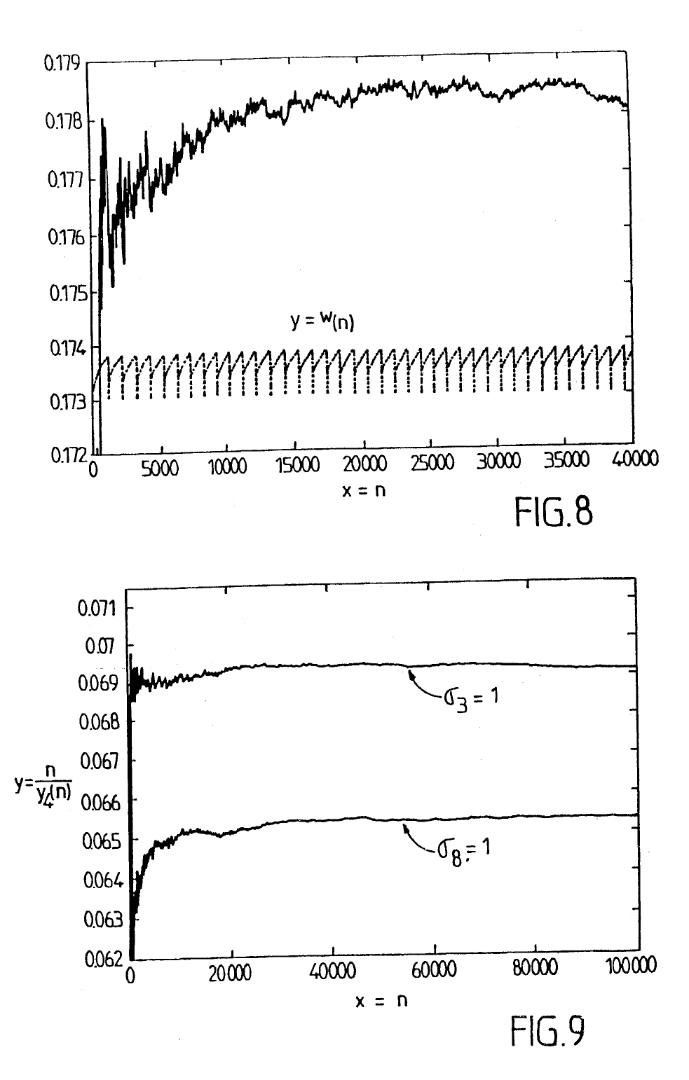

FIG. 8, a variation in output (curve in solid lines), obtained by simulation, in a TCP-protocol network based on a Tahoe model with exponential phase,

FIG. 9, compared output variations, obtained by simulation, in a TCP-protocol network based on a Tahoe model with services s₃ and s₈ respectively which are constant and equal to 1, and

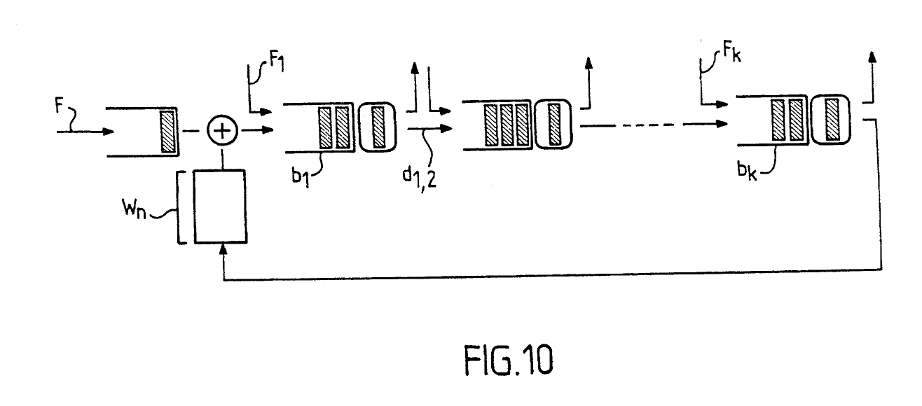

FIG. 10, diagrammatically a network with its queues and its routers.

Appendix I comprises the formulae and equations E1 to E28 to which the detailed description below refers,

Appendix II comprises the bibliographical references [1] to [13] indicated in brackets in the description below.

The drawings, appendices and description below contain essentially elements of a definite character. Therefore, they may not only serve to explain the present invention but also contribute to its definition if necessary.

Referring to FIG. 1, the device takes the form of a computer comprising a central processing unit UC equipped with a microprocessor μP, which cooperates with a mother map CM. This mother map is connected to various pieces of equipment, such as a communication interface COM (modem or other type), a read-only memory ROM and a random access memory RAM. The mother map CM is further connected to a graphic interface IG, which pilots the display of data on a screen ECR forming part of the device. Also provided are acquisition means such as a keyboard CLA and/or an acquisition element known as a “mouse” SOU, connected to the central processing unit UC and allowing the user to interact with the device.

The ROM memory, or even the RAM memory stores the above-mentioned first set of data representing network parameters (topology, router properties, etc). In the example, the RAM memory receives the above-mentioned second set of data representing events in the network (transverse flux, congestion, losses, etc.). In the context of an aid to monitoring of the network, these second data may be received by the communication interface COM. In the context of simulation, the acquisition of these second data may be effected by a calculation based on a simulation model, as will be seen below.

The RAM memory at least may be addressable according to rows and columns of matrices and thus permit the storage of data in matrix form.

The ROM memory comprises a modelling unit MOD which, in cooperation with the microprocessor μP makes it possible to construct the first above-mentioned matrix and a current matrix, respectively according to the first data and the second data according to a selected model shown below.

The ROM memory comprises a unit CAL which, in cooperation with the microprocessor μP makes it possible to carry out on at least two matrices with a dynamically variable structure an operation giving rise to a product according to MAX-PLUS algebra. In the example, ‘matrices with a dynamically variable structure’ means matrices whose coefficients at least are dynamically variable. Advantageously, the models which will be described below make it possible to return the matrices constructed (and more particularly the current matrices) to matrices of which only the coefficients are dynamically variable.

The modelling unit MOD therefore comprises:

a static modelling sub-unit ST for constructing the first matrix according to a first set of data, and

a dynamic modelling sub-unit DYN for constructing, according to the second set of data, at least one current matrix whose coefficients are dynamically variable.

The ROM memory further comprises a unit PIL which, in cooperation with the microprocessor μP, makes it possible to apply iteratively the first above-mentioned matrix (comprising the first set of data) and the current matrix (comprising the second set of data) to the computing unit CAL. The product matrix obtained is stored in the memory and becomes a new first matrix. It may then be multiplied (according to MAX-PLUS algebra) by another current matrix, comprising new second data representing new events in the network.

Various approaches have been proposed for apprehending the key properties of the TCP-type flux control mechanism with a window, in particular from heuristic considerations simulations, fluid approximations, or markovian analyses, references [10, 11, 1, 12, 13, 14]. All the analytical models are based on the reduction of the network to a single node representing the bottleneck [9].

Furthermore, it has been recently demonstrated that the window-type flux control of a multidimensional network admits a linear max-plus representation when the size of the window is constant (reference [5]). Here, the Applicants prefer models which combine the adaptive TCP control mechanism and a multidimensional network formed of a plurality of routers in series. The dynamics of such a controlled network is advantageously described in ‘packages’ via iterations of matrix products in the max-plus algebra. Being considered here are both a case where the transmission times of the packages are determinist and the various stochastic models which have been used in the prior art, in particular cases where there are random losses in addition to the losses due to exceeding the capacity of the buffer memories, and the case where the transmission times of the packages are randomly disrupted by the other traffic.

Many key aspects of the protocol may be shown: congestion losses, random losses, delays (or ‘time-out’) in propagation or delays due to waiting or again due to the flux control mechanism, etc.. As will be seen below, this approach makes it possible to obtain explicit formulae for the maximum allocated output, when the disruptions are determinist or random. These formulae are asymptotically compatible with known formulae when the maximum size of the window tends towards infinity.

Moreover, it is possible with the present invention to analyse instantaneous and random fluctuations in output, which may be useful in estimating the quality of services offered at a connection. It can be adapted equally well for effective simulations of dynamics of a TCP session operating under control, end-to-end, on a large-scale network.

Below is given a general max-plus representation of the base model used by the present invention. Afterwards, the determinist services with an evolution which is determinist and then markovian of the size of the window are described. The Applicants have shown that for these determinist models, the output only depends on the ‘round-trip time’ or RTT of the pass band (or bandwidth). Modifications and extensions of the determinist model have also been implemented, in particular:

the case of random losses in addition to congestion losses;

detailed tracking of the buffer size and of the congestion losses;

the case of random services;

the case where there are time-outs.

The extensions of the determinist model all lead to analytical formulae or to new principles of simulation based on calculation of the product of a large number of matrices. In particular, the Applicants have shown that the cost of simulation by this method of transmission of n packages on K routers is advantageously in 2n(Kwₘₐₓ)², where Wₘₐₓ is the maximum size of the window.

The scalar max-plus algebra is a semi-ring on the real straight line where addition is replaced by max (notated (+)) and multiplication by plus (notated (×)). The law (×) is distributive relative to the law (+), which makes it possible to extend the usual concepts of linear algebra to this framework, and in particular the theory of matrices. This semi-ring is notated (Rₘₐₓ(+)(×)), where Rₘₐₓ is the real straight line complemented with minus infinity, which is the neutral element of (+). Consequently, the entirety of the square matrices of dimension d in this algebra is notated (Rₘₐₓ (+)(×)), where the two operations (+) and (×), when applied to matrices, are linked by the relation E1 of appendix I.

For further details of this algebra, which is also used for QoS guarantees in networks, one can refer to [2] or [6] in the references given in appendix II.

In a PAPS network, of the ‘first-come, first-served’ type, having K queues in tandem, the nth client arriving at the station i receives a service σᵢ(n). In the framework of TCP, this network models a single source sending packages to a single destination via a path composed of K routers. The variable σᵢ(n) is the random delay caused by the transverse traffic (the other users) at router i on the nth package. This delay does not include the waiting delays, but only the slowing of the speed of the server due to the presence of transverse traffic. The delay in propagation of the nth package between the routers i to j is notated below as d_{i,j}(n).

The input flow rate is controlled by a dynamic window W(n), whose size is equal to the total number of packages sent by the source at a given instant and not having reached the destination (or more precisely the packages which have not yet been ‘fulfilled’).

The size of the window has a general evolution defined by the recurrence E2 given in the appendix.

In the equations E2, ACK(n) is the flux/congestion control signal giving the information on the state of the system at the time n and where f is a function specified below.

For example, ACK(n)=1 if no congestion (or no loss of package) is observed by the nth package, otherwise ACK(n)=0. Consequently, and in certain cases, f is assumed to depend also on Ws, which is, for TCP models, the threshold separating the exponential growth phase (known as ‘slow-start phase’) from the linear growth phase (known as ‘congestion-avoidance phase’).

The recurrence relation (given as an appendix in E3) defines a reference size of the window. The actual size is then defined as the entire part of the reference size according to the equation E3 of the appendix.

The maximum size of the window is supposed to be finite and is notated w* (see the equation E4 of the appendix).

Moreover, the evolution of the size of the window may be broken down into two phases depending on ACK(n) in the following manner: a growth phase defined by E51 and a reduction phase defined by E52.

In the model described here, ACK(n) (worth 0 or 1) is the fulfilment signal of the nth package which detects a state of congestion or loss of a package. The usual examples of the ideal politics of the evolution of the window are given by equations E61 to E67 of the appendix, wherein the real α is strictly between 0 and 1. The relations E61 and E62 are given respectively for exponential and linear phases.

In the following examples, the value of α is fixed at ½.

The queue at the inlet is considered hereafter as saturated (even if the non-saturated case can be easily integrated, as will be seen below). The network therefore behaves like a closed network and its output gives the maximum rate at which the source can send packages whilst retaining a stable inlet buffer. Article [5], mentioned in the appendix, can be consulted for more details on this case.

FIG. 1 will be referred to, which shows K queues in tandem, with flux control. xᵢ(n) is the date at which the nth package arriving at the router i begins its service on this router.

yᵢ(n) is the date at which the nth client leaves the router i. From the formulae E7 of the appendix, the vector Z(n), known as the ‘dater vector’ below, can be deduced.

The variables Mi, i belonging to {1, . . . , w*}, are matrices given of (Rₘₐₓ). C is the matrix of (Rₘₐₓ) of which all the elements are equal minus infinite. Below, the matrix of (Rₘₐₓ) is notated (M1|M2| . . . |Mw*) defined by blocks of size k×k. The Applicants have shown that all the blocks are equal to the matrix C of (Rₘₐₓ), except for the first line of blocks, which is equal to M₁, M₂, . . . Mw*. The Applicants have also shown that if initially the system is empty, the evolution of the vector of the daters Z(n) is given by the linear max-plus recurrence E8.

In the formula E8, D is the matrix of dimension Kw* of which all the elements are equal minus infinite except those of the form Dk_{+i,i} (where i belongs to {1, . . . , k(w*−1)}), which are all equal to 0.

The exponent of Lyapunov of the station k can be defined by the limit of the expression yₖ(n)/n when n tends towards the infinite. Due to monotony, it is clear that this limit is independent of k. This property is more generally true under the hypothesis of irreducibility defined in reference [8].

At the level of the representation described here, error control is not taken into account and no difference is marked between the original packages and those that are re-transmitted. In particular, so far no distinction has been established between the ‘send rate’, ‘throughput’ or ‘goodput’ in the sense of reference [13].

The equation E8 is, in this embodiment, the basis of the algebraic simulation diagram to which it has been alluded above. As the matrices A_{wn-1}(n) have the dimension Kw*, and as only the matrix-vector products are necessary, the controlled transmission of n packages through the network can be simulated in 2n(Kw*)² operations on a single processor.

FIG. 2A shows an example of explicit step-by-step evolution of the daters and of the size of the window (K=5 where (σ₁, . . . , σ₅)=(1, 1, 2, 1, 1) and w*=4). The evolution of the size of the window is determinist (TCP Tahoe without the slow-start phase, i.e. (w₁, w₂, w₃, . . . )=(1, 2, 2, 3, 3, 3, 4, 1, 2, 2, . . . )).

For example, the package #5 corresponds to the size of the window 3, which is notated 5(3) in FIG. 2A. Thus just after transmission of the package #5, three packages in the network have not yet been ‘fulfilled’. As FIG. 2A shows, the delays imposed on the packages (see for example package #6) in the internal routers may be quite complex.

For simplicity of presentation, we shall first consider the case where all the propagation delays d_{i,j}(n) are worth 0, and then an adaptation to cover the case of non-zero propagation delays.

In a first approximation, the services σ₁(n) are all determinist and constant (σᵢ). Congestion is normally detected by the politics of the formula E9.

Such detection may be interpreted as giving the rate of service 1/σ* of the bottleneck of the network and S a round-trip time RTT. Therefore, congestion is detected when the average emission rate (wₙ/RTT) reaches the rate of the bottleneck. For the model with a static window, w* is the size of the window given by the product: pass-band×delay (reference [9]).

The Applicants have shown that, in these conditions, w* is given by the formula E10 and that wₙ becomes periodic with a period T which may be broken down into t₁+t₂+ . . . +t_{w}, where ti is the number of occurrences of wₙ=i during a period.

First considering the Tahoe TCP model without the exponential phase, under the E9 politics, the formulae E11 of the appendix can be deduced. The matrix H (formula E12) is irreducible and its eigenvalue is equal to nS+σ*. The Applicants have also shown that if all the delays are determinist, this eigenvalue is given by the formula E13.

Consequently, the output depends on the delays (σ₁, . . . σₖ) only through S and σ*, and this output is given by the formula E14. Thus the asymptotic output becomes 1/(2σ*) when w* tends towards infinity.

In FIG. 2 (where it is assumed that w*=6) the step-by-step evolution of the input date y₀(n) and the departure date yₖ(n)(of the package #n) are shown. The algebraic properties above are interpreted as follows.

Before detection of congestion, the packages sent behave as if there were no interaction between them except for the couple of packages sent at the same time when the size of the window grows from one unit. For these packages, the second package always leaves the station K with a delay of σ* relative to the first. The eigenvalue 5S+6σ* can therefore be read directly from the graphic evolution.

The saturation output for the Tahoe TCP with the exponential phase is given for the formula E15 and the asymptotic output (w* infinite) is given by E16.

FIG. 3 shows the rate of the relation n/y₄(n) (solid lines) and of Wn (dotted lines) in the following conditions: Tahoe TCP without the exponential phase with four queues in tandem (σ₁=3.2; σ₂=4.61; σ₃−2.7; σ₄=4.61 and w*=4). The saturation output is equal to 0.140084 using formula E14.

A determinist periodic evolution of Reno TCP has been considered in reference [11] in order to obtain a heuristic value of the output. The max-plus representation above leads to a new formula which refines than of [11].

If all the delays are determinist, the saturation output only depends on S and σ* and is given by the formulae E17 of the appendix.

Referring to FIG. 4, the asymptotic outputs (case 1, case 2, and case 3) are obtained quite intuitively from the fluid approximation of the evolution of the window size.

The output corresponding to wₙ−w* (case 0) is called dₒ=1/σ*; when wₙ increases linearly from 1, the volume of output, which is proportional to the integer of W(t) over a period, is in fact ½.dₒ (case 1); when wₙ increases linearly from w*/2, the output volume decreases by a factor of ¾ (case 2).

The well-known formula of the output of a TCP connection as a function of the rate of loss pₚₑᵣₜₑ and of the round-trip time RTT is in the form given by the reference [11] and re-transcribed by:

output=cₒ/RTT (pₚₑᵣₜₑ)^{1/2})

where cₒ is a real constant.

For the determinist model above, where RTT=S, the values of pₚₑᵣₜₑ according to the various cases (C1, C2, C3) are expressed according to the formulae E18.

Consequently, for the large values of w* (or the small values of pₚₑᵣₜₑ), the asymptotic formula does coincide with that of reference [11].

The Applicants have verified that all the above results are true for constant delays in propagation d_{i,j} on condition that the value S is replaced by that of formula E19 of the appendix.

For determinist models, the output obtained may be compared to that simulated by a simulator (e.g. of the NS type) by selecting an arbitrary package size and taking a service speed of the router i corresponding to σᵢ. The differences between outputs obtained by the simulation NS and by the formulae above can only arise here from differences on the mechanisms for detecting loss due to congestion, or from the fact that the entire part of W(n) in f (as in reference [9]) is alone considered here, whereas NS uses W(n). In fact, for all determinist models with the same periodic evolution of W(n), the evolutions are exactly the same. For example, a TCP protocol simulated on NS with an ftp-type source gives, for K=10, a package size equal to 1250 (40 for acknowledgements of receipt), and a size of the buffers equal to 2. All the delays d_{i,j} are equal to 0.1 ms, except for dₖ₀, which is equal to 1 ms. The service speed is worth (10, 5, 4, 2, 5, 4, 5, 5, 4, 5, 5)Mb/s for links 0-1, . . . , 9-10, 10-0. At t=100 s, the simulator NS gives 152.27 packages/s. For this example, S=25.5 ms and σ*=5 ms; therefore, with the formula E15, one would have 134 packages/s. However, w* is in fact equal to 7 in the simulation NS instead of 6 in the model described here. A RTT is necessary to detect what is known as a ‘triple-acks’ timing on this model NS. By evaluating the output with the formula E15 and w*=7, 152.55 packages/s are obtained.

Finally, for all determinist models, the sequence {wₙ} is determinist, and the evolution of emission output can be calculated exactly from the products of corresponding max-plus matrices.

Below, a Markov model is described having determinist services.

The services are all considered determinist. Now. W(n) is assumed to evolve independently of the other elements of the network by the markovian transition matrix P given by the following formulae:

for every whole n,

if w(n)<wₘₐₓ, w(n+1)=

w(n) with probability Po

h(w(n)) with probability P+

g(w(n)) with probability P−

if W(n)=Wₘₐₓ W(n+1)=g(w(n)) with probability 1,

where h(W(n))>W(n), g(W(n))<W(n) and where Wₘₐₓ is arbitrary.

If all the services are determinist, for any markovian evolution of W(n) with the above structure, the output only depends on the delays through S and σ*. Moreover, the Lyapunov exponent γ (the inverse of output) is of the form given by the formula E20 in which π is the stationary probability of the set A.

In the case where both transitions are possible, w* may be defined by the politics E9 and Wₘₐₓ=w*, with the politics E21 of the appendix. This model may be compared to that of reference [12], where a global loss probability is used to capture at the same time the time-outs (TO) due to losses of packages and triple duplications of the ACKs (TD) due to congestion. In the model described here, these two mechanisms are, on the contrary, described separately; the losses of packages which generate the TO constitute an i.i.d. (independent and identically distributed) sequence, which is independent of all the other elements of the network and are captured by the parameter p_; the losses due to congestion are captured by the parameter w*.

It is demonstrated that for Tahoe TCP with a markovian evolution as described above (i.e. with E21 and g(W(n))=1), the output is given by the formulae E22.

The Applicants have verified that p_{—}=0 corresponds to the case of determinist Tahoe TCP (without exponential phase). Furthermore, if the losses of packages are linked to congestion in a manner which is on average similar to those of the case of determinist Tahoe TCP, the parameter Cₒ is worth 60%; hence the degradation of performances may be significant (approximately 15%) when one changes from the determinist model (or Cₒ=0.71) to the markovian model. The impact of T0s on performances has already been noted, for example in the references [13, 10]. The preponderant influence of p_ on the probability of global loss may be quantified from the analytical model above as follows.

The probability of global loss of this model is given by:

μ(w*)+p_(1−μ(w*))=μ(1)

where μ(w*) is the loss due to congestion and p_(1−μ(w*) is the loss due to T0s.

For μ(1) fixed, FIG. 5 shows the decrease of output in p_(σ*=1 and S=w*−1).

It can be seen here how preponderant the impact of losses by T0 is relative to losses due to congestion.

By applying the models above to buffer memories of a network, similar results are obtained for models of the Reno TCP type and also for models based on a markovian evolution of the size of the window with three transitions (or more).

For example, let K=4 where σ₁=3.2; σ₂=4.61; σ₃=2.7; σ₄=4.61, and w*=4. FIG. 6 shows the evolution of n/y₄(n) and wₙ for markovian Reno TCP where (p+, p₀, p_)=(0.8, 0.1, 0.2)). In the determinist case, the outputs are equal to 0.140084 (Tahoe) and 0.172166 (Reno). The outputs of the determinist model seem to be higher than those of the markovian models.

For finite buffers, queues in tandem with determinist services and having a fixed buffer size b for all stations are considered first. In this case, according to the Little formula, it is natural to define detection of congestion with the formula E23.

This model again leads to a determinist, periodic behaviour of Wₙ and to an analysis similar to that described above. It will be noted that the model of the politics E9 is a particular case of E23 with the buffer size b=1.

For random services, queues in tandem with random services and a fixed buffer size b for all stations are now considered. The supports of the service times are assumed to be limited.

Then the relations E24 expressed in the appendix are considered.

W(n) has a determinist evolution when W(n) belongs to {1, . . . , b} and a random evolution when it belongs to {b+1, . . . , b+k}. The interpretation of this model is as follows: for an evolution of the window size of the TCP type, the start date of congestion is the moment when

w(n)=S(n)/σ*(n).

Then, a package loss takes place when the number of packages in the system exceeds the buffer size, which corresponds substantially to the event W(n)=b+r(n).

Another interpretation is as follows: b is an arbitrary size (e.g. half the real size of the buffer), such that if the number of packages waiting exceeds this threshold, congestion is detected.

Under the E24 politics, if the service time vectors σ₁, . . . , σₖ are i.i.d in n, the Tahoe TCP output without exponential phase is given by the expression E25, where 0 is the vector (0, . . . , 0)^{t} of R^{k,1}.

The time-out mechanisms may be taken into account, e.g. by the condition S(n)>T0 or by the condition:

yₖ(n)−yₖ(n−ₙ₋₁)>T0.

For example, as soon as Z(n) is markovian and the support D of absolute values {yₖ(n)−yₖ(n−wₙ₋₁)} is finite, one finds the same regenerative structure as above. The law of a cycle of regeneration T1 can be calculated explicitly by the recurrence E26 of the appendix.

This recurrence formula is valid for n<Wₘₐₓ. Thus, it is possible to obtain a formula for the output by using the ergodic theorem for regenerative processes as above.

The person skilled in the art may obtain a similar formula for Tahoe TCP with exponential phase or Reno TCP, and also for various extensions of the above model by including package losses as following the formula E21 above.

In another example where four queues in tandem are being considered, with a buffer size b=50 and an independent multinomial distribution for the services, FIG. 8 shows the evolution of n/y₄(n) and W(n) for the Tahoe TCP model with the exponential phase and where b=50. The σᵢ(n) are i.i.d. and mutually independent at values in {1, 5, 10} with respective probabilities of 0.3, 0.4, 0.4.

FIG. 9 shows a comparison of the outputs of two Tahoe TCPs with the exponential phase: b=10 and K=10. In the first case, σ₃(n)=1 and {σⱼ(n) (where j≠3)} is a sequence i.i.d., at values in {1, 10, 20} with the respective probabilities 0.3, 0.2, 0.5. In the second case, σ₈(n) is constant equal to 1 and the other services are as above.

The calculation of outputs by means of the formula E25 shows that the permutation of characteristics of two routers may change the value of output. Therefore, again in this case, the model cannot be reduced to a model with a single server, that of the bottleneck. It should be noted also that the knowledge of average values is insufficient for predicting the value of average output.

The model described above has numerous applications, in particular:

relating to the law of instantaneous outputs which, in the framework of the formula E20, is equal to the expression E27 of the appendix: this is a large value which may define a natural indicator of QoS as a complement of the average value;

the law of end-to-end delays (formula E28);

the law of the time T necessary to the transmission of a file of size F; in a first approximation, this law is given by the relation: P(T>t)=P(yₖ(F)>t), but a more precise formula can be given by taking into account retransmissions of lost packages.

In this context, the following problems can be processed at least in the context of algebraic simulation:

open models (where the source is not saturated: HTTP instead of FTP) where the process of arrivals is described by its statistical characteristics;

multiple connections and interactions between a plurality of users;

multi-point connections through a network with an arborescent structure instead of a linear structure of routers in series (see reference [7] for the case with a constant window).

Some specifications are given below on the structure of an algebraic simulator which would make it possible to foresee the performances of TCP or other flux control mechanisms arising from TCP in already existing IP networks or those being designed.

The basic principle of this simulator is analysis of a controlled connection. The simulation of this connection begins with the acquisition of data concerning the network:

number of routers crossed by the connection, characteristics of each of the routers: capacity in Mb/s, buffer size bi, predictions, etc.;

delays in propagation on each of the links (d_{i,i+1});

statistical features of the transverse fluxes Fᵢ when these are known (as for example in the case of the Internet backbone routers);

statistical characteristics of the traffic offered by the controlled connection;

statistical characteristics of traffic offered by the other fluxes in competition with the controlled connection on the access router.

The characteristics appear in FIG. 10.

One then constructs from these data and characteristics of the TCP version selected (or of the retained flux control algorithm) an algebraic simulator which consists in the step-by-step construction of the matrices A_{wn} above and calculation by recurrence of the system daters as indicated.

From the mathematical analysis presented above, it can be deduced that calculations can be made from the simulation of the main characteristics of the TCP effect on the controlled connection (average output, output averaged over a given period of time, instantaneous fluctuations in output, etc.).

In order to complement this description of the simulator, some indications on the manner of taking into account certain fine mechanisms are given below.

For a router i, let bi be the size of its buffer by flux; the detection of exceeding of this capacity is effected by the following condition on the daters:

xᵢ(n+bᵢ)≦yᵢ(n)

As already indicated, the precise mechanisms of time-outs can be taken into account by the condition:

y_{K}(n)−y_{K}(n−wₙ₋₁)>T0.

This formulation is also valid when there is an evolution of T0 itself (in certain versions, the variable T0 is updated at each time-out: T0 is doubled in the case of a time-out, until 64 times the value of initialisation has been reached). The present invention can be applied to the estimation of variations and adaptations of the window in the framework of linear max-plus. The variations and adaptations of the variable T0 are apparent in nature and are therefore also representable in this context.

In certain versions of TCP it is recommended to proceed to the regrouping of acknowledgements of receipt. For example, one may be waiting for three packages to arrive at the destination in order to send back a single acknowledgement for the three. This can also be shown by means of a concatenation of two variable-window mechanisms, and quite naturally re-enters the framework of a linear max-plus description.

A scheduling mechanism in a router (e.g. first-come, first out ‘FIFO’ (or Weighed Fair Queueing) possibly with differentiations in services) can be shown in this simulation by taking into account the effect of this mechanism on the service durations σᵢ(n); once calculated according to the transverse traffic, the traffic of the controlled connection, and the scheduling mechanism, these random durations can be injected into the simulator.

For access network infrastructures being designed, one can obviously not measure the statistical characteristics of the transverse traffic on the access routers. Assuming that one has a statistical description of the traffic offered provided on the access routers of this network (e.g. N HTTP traffics), the simulator can be used to calculate the unknown transverse traffic as a fixed point in the system: let t be the law of traffic of the controlled connection observed at the access router; t must be such that if one takes as traffic offered on the control connection that of a HTTP session,

the controlled connection traffic observed on the access router has t as its law; and

the transverse traffic observed at this point is the total of N traffics of the law t.

Thus, in networks which are saturated or otherwise, the TCP adaptive feedback control mechanism is a linear feedback in max-plus algebra. This leads to a simple representation of the effect of this protocol on any network which itself admits a max-plus representation in the absence of the control, as is the case for example for queues in tandem or fork-join networks which are found in multi-point trees.

The formulae above confirm that in this case, the output only depends on the RTT and on the rate of the bottleneck. New formulae have also been obtained when the services are random. The chances here represent the effect of the rest of the traffic on the controlled connection. In this case, the output cannot be obtained only from average considerations, and the order and statistical behaviour of the routers cannot be ignored.

The set of models in this framework is very rich:

one can in effect select determinist or random services, a flux control based on loss or congestion;

the losses can arise from congestion or time-outs, or be random, or even be a combination of these three possibilities;

a Reno or Tahoe version can be selected, with or without exponential phase, etc.

The present invention finds advantageous applications in the analysis of these few combinations, since all the combinations can be analysed in principle in this framework.

More generally, the invention defines a generic framework for the simulation of TCP-type protocols on networks which may be large. Simulation is based on a simple process which exploits linearity and which has a controlled complexity.

Obviously, the invention is not limited to the embodiment described above by way of example: it extends to other modifications which nevertheless remain defined in the context of the following claims.

$$E1 : {( A ⊕ B )}_{ij} = {A}_{ik} ⊕ {B}_{kj} = max ( {A}_{ik} , {B}_{kj} ) , {( A ⊗ B )}_{ij} = {⊕}_{1 \leq k \leq d} {A}_{ik} ⊗ {B}_{kj} = {max}_{1 \leq k \leq d} {A}_{ik} + {B}_{kj} .$$

W(0)=1, W(n+1)=f(W(n), ACK(n)),

wₙ=(int) W(n)=└W(n)┘.

$$E4 : {w}^{*} = {max}_{n ∈ N} {w}_{n} = ( int ) {W}_{max} = ⌊ {W}_{max} ⌋$$

{n: ACK(n)=1}, 0≦f(W(n),1)−W(n)≦1,

{n: ACK(n)=0}, 1≦f(W(n),0)≦W(n).

TCP, Tahoe:

$$E61 : f ( W ( n ) , 1 , {W}_{s} ( n ) ) = W ( n ) + 1 ; W ( n ) < {W}_{s} ( n ) , \\ E62 : = W ( n ) + \frac{1}{{w}_{n}} ; W ( n ) \geq {W}_{s} ( n ) ,$$

W,(n+1):=W,(n);

f(W(n), 0, W,(n))=1;

W,(n+1):=└αW(n)┘.

TCP, Reno

$$E66 : f ( W ( n ) , 1 ) = W ( n ) + \frac{1}{{w}_{n}} ,$$

f(W(n), 0)=└αW(n)┘.

∀n≧0, σ₀(n)=0; yᵢ(n)=Iᵢ(n)+σᵢ(n) y₀(n)=y_{K}(n−wₙ₋₁)\mathring{×}d_{K,0}(n−wₙ₋₁), yᵢ(n)=[yᵢ₋₁(n)\mathring{×}d_{i-1,i}(n)⊕yᵢ(n−1)]\mathring{×}σᵢ(n), i=1, . . . ,K.

$$\begin{matrix}Y ( n ) = ( {y}_{1} ( n ) , {y}_{2} ( n ) , … , {y}_{K} ( n ) ) ∈ {R}_{max}^{1 , K} \\ Z ( n ) = {( Y ( n ) , Y ( n - 1 ) , … , Y ( n - {w}^{*} + 1 ) )}^{t} ∈ {R}_{max}^{K \cdot {w}^{*} , 1} .\end{matrix}$$

Z(0)=(0, . . . , 0)^{t}, Z(n)=A_{w}_{ₙ₋₁}(n)\mathring{×}Z(n−1), ∀n≧1, A₁(n)=(M(n)\mathring{×}M₁′(n)|ε| . . . |ε)⊕D, A₂(n)=(M(n)|M₂′(n)|ε| . . . |ε)⊕D, . . . , A,(n)=(M(n)|ε| . . . |ε|M,′(n))⊕D.

$$M ( n ) : {( M ( n ) )}_{ij} = {\sum }_{k = j}^{i} {σ}_{k} ( n ) + {\sum }_{k = j}^{i - 1} {d}_{k , k + 1 ( n )} [ i \geq j ] ; - ∞ [ i < j ]$$

$${M}_{e}^{1} ( n ) : {( {M}_{l}^{i} ( n ) )}_{ij} = {\sum }_{k = 1}^{i} ( {d}_{k - 1 , k} ( n ) + {σ}_{k} ( n ) ) + {d}_{K , 0} ( n - l ) [ j = K ] , - ∞ [ j < K ]$$

$$E9 : ACK ( n ) = 1 [ {w}_{n} \leq \frac{S}{{σ}^{*}} ] ; 0 [ {w}_{n} > \frac{S}{{σ}^{*}} ]$$

$$E10 : {w}^{*} = min \{ n : {σ}^{*} n > S \} = ⌊ \frac{S}{{σ}^{*}} ⌋ + 1 \leq K + 1.$$

$$E11 : \{ {w}_{1} , {w}_{2} , … \} = \{ 1 , 2 , 2 , 3 , 3 , 3 , … , \underbrace{{w}^{*} - 1 , … , {w}^{*} - 1}_{{w}^{*} - 1} , {w}^{*} , 1 , 2 , 2 , … \} . \\ ⇒ ∀ i ∈ \{ 1 , … , {w}^{*} - 1 \} , {t}_{i} = i ; {t}_{{w}^{*}} = 1 ; T = \frac{{w}^{*} ( {w}^{*} - 1 )}{2} + 1$$

$$Z ( n \times T + 1 ) = {( {A}_{{w}^{*}} {A}_{{w}^{*} - 1}^{{w}^{*} - 1} … {A}_{1} )}^{n} ⊗ {A}_{1} ⊗ Z ( 0 ) . \\ ∀ i \geq 1 , \\ {A}_{i}^{i} = ( \begin{matrix}{M}^{i} ⊕ {M}^{′} & {MM}^{′} & ⋯ & ⋯ & {M}^{i - 1} {M}^{′} & ϵ⋯ \\ {M}^{i - 1} & {M}^{′} & ⋰ & ⋰ & {M}^{i - 2} {M}^{′} & ⋮ \\ ⋮ & ϵ & ⋰ & ⋰ & ⋮ & ⋮ \\ {M}^{2} & ⋮ & ⋰ & {M}^{′} & {MM}^{′} & ⋮ \\ M & ⋮ & ⋮ & ϵ & {M}^{′} & ⋮ \\ {I}_{d} & ϵ & ⋮ & ⋮ & ϵ & ⋮ \\ ϵ & {I}_{d} & ϵ & ⋮ & ⋮ & ⋮ \\ ⋮ & ⋰ & ⋰ & ⋮ & ⋮ & ⋮\end{matrix} )$$

$$∀ i \geq 1 , ∀ n ∈ \{ 1 , … , i - 1 \} , \\ {A}_{i}^{n} = ( \begin{matrix}{M}^{n} & ϵ ⋯ ϵ & {M}^{′} & ⋯ & {M}^{n - 1} {M}^{′} & ϵ⋯ \\ ⋮ & ⋮ & ϵ & ⋰ & ⋮ & ⋮ \\ M & ⋮ & ⋮ & ⋰ & {M}^{′} & ⋮ \\ {I}_{d} & ϵ ⋯ ϵ & ⋮ & ⋮ & ϵ & ⋮ \\ ϵ & {I}_{d} ϵ ⋯ ϵ & ⋮ & ⋮ & ⋮ & ⋮ \\ ⋮ & ⋰⋰⋮ & ⋮ & ⋮ & ⋮ & ⋮\end{matrix} )$$

∀n≦w*−1, M\mathring{×}(M,⊕M′)\mathring{×} . . . \mathring{×}(M⊕M′)

λ=(w*−1)S+σ*.

$$E14 : {γ}^{- 1} = \frac{1}{2} \frac{{w}^{*} ( {w}^{*} - 1 ) + 2}{( {w}^{*} - 1 ) S + {σ}^{*}} . \\ E15 : {γ}^{- 1} = \frac{1}{2} \frac{{w}^{*} ( {w}^{*} - 1 ) - ⌊ \frac{{w}^{*}}{2} ⌋ ( ⌊ \frac{{w}^{*}}{2} ⌋ - 3 )}{( {w}^{*} + 1 - ⌊ \frac{{w}^{*}}{2} ⌋ ) S + ( ⌊ \frac{{w}^{*}}{2} ⌋ - 1 ) {σ}^{*}} . \\ E16 : {w}^{k} \to ∞ ⇒ {γ}^{- 1} ∼ \frac{3}{4} \frac{1}{{σ}^{*}} . \\ E17 : {γ}^{- 1} = \frac{1}{2} \frac{{w}^{*} ( {w}^{*} - 1 ) - ⌊ \frac{{w}^{*}}{2} ⌋ ( ⌊ \frac{{w}^{*}}{2} ⌋ - 1 ) + 2}{( {w}^{*} - ⌊ \frac{{w}^{*}}{2} ⌋ ) S + {σ}^{*}} . \\ {w}^{↖} \to + ∞ ⇒ {γ}^{- 1} ∼ \frac{3}{4} \frac{1}{{σ}^{*}} . \\ E18 : \begin{matrix}C1 : {p}_{perte} = \frac{2}{{w}^{*} ( {w}^{*} - 1 ) + 2} , ⇒ {C}_{o} = \frac{1}{\sqrt{2}} ( {w}^{*} \to ∞ ) \\ C2 : {p}_{perte} = \frac{2}{{w}^{*} ( {w}^{*} - 1 ) - ⌊ \frac{{w}^{*}}{2} ⌋ ( ⌊ \frac{{w}^{*}}{2} ⌋ - 3 )} , \\ C3 : {p}_{perte} = \frac{2}{{w}^{*} ( {w}^{*} - 1 ) - ⌊ \frac{{w}^{*}}{2} ⌋ ( ⌊ \frac{{w}^{*}}{2} ⌋ - 1 ) + 2} . \} {C}_{o} = \sqrt{\frac{3}{2}} ( {w}^{*} \to ∞ )\end{matrix}$$

$$E19 : S = {d}_{K , 0} + {\sum }_{k = 1}^{K} {σ}_{k} + {d}_{k - 1 , k} . \\ E20 : Δ = \{ S - ( {k - 1 ) {σ}^{*} , k = 1 , … ,}^{γ = {\sum }_{α ∈ Δ}^{} {απ ( α )}_{i}} {w}^{*} - 1 \} ⋃ \{ {σ}^{*} \} . \\ A = {\{ {y}_{K} ( n + 1 ) - {y}_{K} ( n ) \}}_{n ∈ N } \\ E21 : h ( W ( n ) ) = W ( n ) + \frac{1}{{w}_{n}} ; {p}_{0} = 0. \\ E22 : q ( k ) = \frac{{p}_{+}^{\frac{h ( h + 1 )}{2} - 1} {p}_{-}}{1 - {p}_{+}^{\frac{{w}^{*} ( {w}^{*} - 1 )}{2} + 1}} ; {γ}^{- 1} = \frac{1}{{σ}^{*} + {\sum }_{k = 1}^{{w}^{*} - 1} [ S - k {σ}^{*} ] q ( k )} , \\ \begin{matrix}{w}^{*} \to ∞ \\ {p}_{-} ∼ \frac{2}{{( {w}^{*} )}^{2}} ,\end{matrix} \} ⇒ {γ}^{- 1} ∼ ( \frac{1 - {ⅇ}^{- 1}}{2 {\int }_{0}^{1} {ⅇ}^{- {t}^{2}} ⅆ t} ) \frac{1}{{σ}^{*}} ≃ 0.42 \frac{1}{σ *} . \\ E23 : ACK ( n ) = 1 , if {w}_{n} < b + \frac{S}{σ *} , 0 , if {w}_{n} \geq b + \frac{S}{σ *} . \\ E24 : \begin{matrix}{σ}^{*} ( n ) = {max}_{1 \leq i \leq K ( {σ}_{i} ( n )} \\ S ( n ) = {\sum }_{i = 1}^{K} {σ}_{i} ( n ) \\ S = sup \{ S ( n ) \} ; {σ}^{*} = sup \{ {σ}^{*} ( n ) \} ; r ( n ) = \frac{S ( n )}{{σ}^{*} ( n )} ; {w}^{*} = b + sup \{ r ( n ) \} \\ ACK ( n ) = \begin{matrix}1 , & {w}_{n} < b + r ( n ) , \\ 0 , & {w}_{n} \geq b + r ( n ) .\end{matrix}\end{matrix}$$

$$E25 : {γ}^{- 1} = \frac{\frac{b ( b + 1 )}{2} + {\sum }_{k = 1}^{K} {\sum }_{i = 0}^{b + k - 1} {p}_{ki} ( i + 1 + {\sum }_{j = 1}^{k - 1} ( b + j ) )}{{\sum }_{k = 1}^{K} {\sum }_{i = 0}^{b + k - 1} {p}_{ki} E [ {( B ( \frac{b ( b + 1 )}{2} + i + 1 + {\sum }_{j = 1}^{k - 1} ( b + j ) ) ⊗ 0 )}_{K} ]} , \\ {p}_{ki} ( {\prod }_{j = 1}^{k - 1} {P ( r ( n ) > j )}^{b + j} ) {P ( r ( n ) > k )}^{i} P ( r ( n ) \leq k ) . \\ E26 : \begin{matrix}P ( {T}_{i} > n , {Z}_{n} = z ) = P ( {⋂}_{k = 1}^{n} \{ {y}_{K} ( k ) - {y}_{K} ( k - {w}_{k - 1} ) < TO , {Z}_{n} = z ) \\ = {\sum }_{{x}^{′} ∈ Δ}^{} P ( {⋂}_{k = 1}^{n} \{ {y}_{K} ( k ) - {y}_{K} ( k - {w}_{k - 1} ) < TO , {Z}_{n - 1} = {z}^{′} , {Z}_{n} = z \\ = {\sum }_{{x}^{′} ∈ Δ}^{} P ( {Z}_{n} = z , {y}_{K} ( n ) - {y}_{K} ( {w}_{n - 1} ) < TO \vert {Z}_{n - 1} = {z}^{′} ) P ( {T}_{1} > n - 1 , {Z}_{n - 1} = {z}^{′} ) .\end{matrix}$$

$$E27 : {lim}_{n \to ∞} P ( {( {y}_{K} ( n + 1 ) - {y}_{K} ( n ) )}^{- 1} \leq x ) = {\sum }_{α ∈ Δ}^{} {1}_{\{ α \geq 1 / z \}} π ( α )$$

$$E28 : {lim}_{n \to ∞} \frac{1}{N} {\sum }_{n = 1}^{N} P ( {y}_{K} ( n ) - {y}_{K} ( n - {w}_{n - 1} ) \leq x ) .$$

Annexe II

[1] Altman, E., Bolot, J., Nain, P., Elouadghiri, D., Erramdani, M., Brown, P. and Collange, D. (1997) Performance Modeling of TCP/IP in a Wide-Area Network. INRIA Report, March, N° 3142, INRIA.

[2] Baccelli, F., Cohen, G. Olsder, G. J. and Quadrat, J. P. (1992) Synchronization and Linearity, Wiley.

[3] Baccelli, F. and Hong, D. (1998) Analytic Expansions of (max,+) Lyapunov Exponents. INRIA Report May, N° 3427, INRIA Sophia-Antipolis, To appear in Annals of Appl. Prob.

[4] Baccelli, F., Gaubert, S., Hong, D. (1999) Representation and Expansion of (Max,Plus)—Lyapunov Exponents. Proc. of 37th Annual Allerton Conf. on Communication, Control and Computing, September, Allerton Park.

[5] Baccelli, F., Bonald, T. (1999) Window flow control in FIFO networks with cross traffic. Queueing Systems, 32, 195-231.

[6] Chang, C. S. (1999) Performance guarantees in Communication Networks. Springer Verlag.

[7] Chaintreau, A, Baccelli, F., Diot, C. (2000) Impact of Network Delay Variation on Multicast Sessions Performance With TCP-like Congestion Control, soumission SIGCOMM 2000.

[8] Hong, D. (1999) Equality of the maximum and minimum throughputs of irreducible stochastic max-plus linear systems. In preparation.

[9] Keshav, S. (1997) An engineering approach to computer networking. Addison-Wesley Professional Computing Series.

[10] Lakshman, T. V., Madhow, U. (1997) The performance of TCP/IP for networks with high bandwidth-delay products and random loss. IEEE/ACM Trans. Networking, June.

[11] Mathis, M. Semske, J. Mahdavi, J and Ott, T. (1997) The Macroscopic Behavior of the TCP Congestion Avoidance Algorithm. Computer Communication Review, 27(3), July.

[12] Padhye, J., Firiou, V., Towsley, D. and Kurose, J. (1998) Modeling TCP throughput: a simple model and its empirical validation. Proc. of ACM SIGCOMM.

[13] Padhye, J., Firiou, V., Towsley, D. (1999) A Stochastic Model of TCP Reno Congestion Avoidance and Control. Technical Report, 99-02, CMPSCI, Univ. of Massachusetts, Amherst.

1. Device for assisting the monitoring and/or simulation of a complex system, in particular of a communication network, characterised in that it comprises:
a memory (ROM, RAM) for storing a first set of data representing parameters of the network as well as for receiving at least a second set of data representing events in the network, a portion of the memory being reserved for storing data in matrix form,
a computing unit (CAL) capable of effecting on at least two matrices of dynamically variable structure an operation forming a product according to the algebra known as MAX-PLUS,
a modelling unit (MOD) for constructing at least a first matrix (Z(n)) and a current matrix (A(n)) respectively according to the first set of data and second set of data according to a selected model, and
a pilot unit (PIL) for applying iteratively the first matrix and the current matrix to the computing unit, the product matrix obtained (Z(n+1)) becoming a new first matrix.

2. Device according to claim 1, characterised in that the first set of data comprises data relating to the topology of the network.

3. Device according to claim 2, characterised in that the first set of data comprises the number (K) of routers of the network crossed by a connection to be monitored or simulated and properties of the routers.

4. Device according to claim 3, characterised in that the first set of data comprises memory sizes of the routers (b_{K}).

5. Device according to one of claims 2 to 4, characterised in that the first set of data comprises statistical properties of the traffics offered in the network.

6. Device according to one of the preceding claims, characterised in that the modelling unit comprises:
a static modelling sub-unit (ST) for constructing the first matrix according to the first set of data, and
a dynamic modelling sub-unit (DYN) for constructing at least one current matrix according to the second set of data.

7. Device according to one of the preceding claims, characterised in that the second set of data comprises information relating to losses (p_, p+) in the network.

8. Device according to one of the preceding claims, characterised in that the second set of data comprises information relating to transverse fluxes in the network relative to a controlled connection to be monitored or simulated.

9. Device according to one of claims 7 or 8, characterised in that the second set of data comprises information relating to congestion in the network.

10. Device according to one claims 7 to 9, characterised in that the second set of data comprises information relating to overtaking of delays (T0) in the network.

11. Device according to one of the preceding claims, characterised in that the product matrix represents an output in the network associated with the connection to be monitored or simulated.

12. Device according to claim 11, characterised in that the product matrix represents an average output in the network.

13. Device according to claim 11, characterised in that the product matrix represents fluctuations of an instantaneous output.

14. Device according to one of the preceding claims, characterised in that the modelling unit is contrived to construct a plurality of matrices in a number corresponding substantially to the number of packages in the network.

15. Device according to one of the preceding claims, characterised in that the modelling unit selected comprises the consideration of variable size of a window (wₙ) used to control the number of packages in the network.

16. Device according to claim 15, characterised in that model selected comprises the consideration of a network comprising routers with a ‘first-come, first-served’-type discipline.

17. Device according to one of claims 15 or 16, characterised in that the model selected comprises the consideration of a network comprising routers with a WFQ-type discipline.

18. Device according to one of the preceding claims, characterised in that the model selected comprises the consideration of a network controlled by a TCP-type protocol.

19. Device according to one of claims 15 to 18, characterised in that the model selected comprises the consideration of a determinist service (s).

20. Device according to one of claims 15 to 18, characterised in that the model selected comprises the consideration of a random service (s).

21. Device according to one of the preceding claims, characterised in that the current matrix at least comprises dynamically variable coefficients (Aᵢₖ).

22. Device according to one of the preceding claims, characterised in that the product matrix obtained is a vector shown by a single-column matrix (Z(n)).

23. Method of assisting the monitoring of a complex system, in particular of a communication network, characterised in that it comprises the following stages:
a) obtain first data representing network parameters,
b) construct a first matrix (Z(n)) according to a selected model according to the first data,
c) receive at a selected instant at least a second set of data representing events in the network,
d) construct at least a second matrix (A(n)) of variable dynamic structure according to a selected model according to the second set of data, and
e) carry out on the matrices an operation forming a product according to the algebra known as MAX-PLUS, the product matrix obtained (Z(n+1)) representing the state of the network at the aforesaid selected instant.

24. Method according to claim 23, characterised in that it further comprises the following stage:
f) repeat at selected instants the stages c), d) and e), whereas the product matrix obtained becomes the first matrix after stage e)
which makes it possible to follow a temporal evolution of the state of the network at the selected instants.

25. Method of simulating a complex system, in particular mechanisms for flux and congestion control in a communication network, characterised in that it comprises the following stages:
a) obtain first data representing parameters particular to the network,
b) construct a first matrix (Z(n)) according to a selected model according to the first data,
c) simulate events in the network and provide at least a second set of data representing the events,
d) construct at least a second matrix (A(n)) according to a selected model according to the second set of data, and
e) carry out on the matrices an operation forming a product according to the algebra known as MAX-PLUS, the product matrix obtained (Z(n+1)) representing the state of the network being subjected to the above-mentioned events.

26. Method according to claim 25, characterised in that it further comprises the following stage:
f) repeat, for successive events, stages c), d), and e), whereas the product matrix obtained becomes the first matrix after stage e),
which makes it possible to predict an evolution of the state of the network according to the above-mentioned events.
